(19) United States
(12) Patent Application Publication
(10) Pub. No.: US 2023/0377057 A1
(43) Pub. Date: Nov. 23, 2023

(54) SYSTEMS AND METHODS FOR IMPROVED SOCIAL MEDIA

(71) Applicant: Issac Hayes, III, Atlanta, GA (US)

(72) Inventor: Issac Hayes, III, Atlanta, GA (US)

(21) Appl. No.: 18/082,397

(22) Filed: Dec. 15, 2022

Related U.S. Application Data
(60) Provisional application No. 63/289,731, filed on Dec. 15, 2021.

(51) Int. Cl. G06Q 50/00; G06F 8/61

(52) U.S. Cl. CPC G06Q 50/01; G06F 8/61

(57) ABSTRACT

Systems and methods for improved social media are disclosed. A server receives a request for first social media application software, which is transmitted to a first user device. The server then receives user data that is used to generate a first social media profile. The server receives a subscription enablement request from the first social media profile. After receiving first social media content from the first social media profile, the server permits other social media profiles to access the first social media content. Subscribers to the first social media content can pay for access. Further, the first social media profile can monetize the profile to receive other payments.

### CROSS-REFERENCE TO RELATED APPLICATION

This application claims the benefit, under 35 U.S.C. § 119(e), of U.S. Provisional Patent Application No. 63/289,731, filed Dec. 15, 2021, the contents of which are hereby incorporated by reference herein in their entirety as if fully set forth below.

### FIELD OF INVENTION

The present disclosure relates to systems and methods for improved social media, and more particularly to systems and methods that monetize content provided by social media users while also providing enhanced user experiences.

### BACKGROUND

Currently, various social media platforms exist that provide, for example, audio chat rooms, live streaming, filters, video and photo sharing, likes, comments, and shares. Social media users have enjoyed some of these features for years. A few users have even become content creators who can generate significant profits from their content and newfound celebrity. While some content creators can monetize their content and social media presence, many social media users are often unable to profit from their content.

Accordingly, there is a need for systems and methods for monetizing social media while providing an enhanced social media experience. Examples of the present disclosure are directed to this and other considerations.

### SUMMARY

Disclosed examples provide systems and methods for improved social media.

Consistent with the disclosed examples, various methods and systems are disclosed. In one example, a method for continuous audio streaming during user navigation of a first social media application is disclosed. The method may be implemented with a computing device (e.g., a smartphone or a laptop). The method may include receiving a user request, from a user (e.g., first user account) of the first social media application, to open an audio streaming component of the first social media application. The method may further include displaying the audio streaming component as a graphical user interface on a screen along with the first social media application. Once the audio streaming component is opened, the user can navigate throughout the first social media application while continuously receiving sound. Furthermore, the audio streaming component can remain on the screen along with the first social media application as the user navigates the first social media application. Therefore, as the user navigates the first social media application, the user can receive sound such as music, audio conversations, podcasts, radio, and/or the like via the audio streaming component.

In another example, a method for monetizing a first social media application is disclosed. The method may include establishing a first user account for the first social media application, which can include various demographics about the user (e.g., name, location, gender, age, profession, browsing preferences, etc.). Also, the first user account can include virtual currency in the form of “loves” that is essentially money usable within the first social media application. In some examples, the first social media application may connect to another application (e.g., Apple Store or Google Store) to obtain funds to purchase loves. Thus, either stored loves or loves purchased in real-time can be used by the first user account to pay another user account of the first social media application. For example, a group of users (user accounts) within an audio room can give funds to one another as virtual currency (loves). Or, in another example, the first user account may view a live stream from other user account and decide to give loves to the other user account. The loves may be singular or given as big loves in larger increments of various amounts. Thus, the first user account can give funds in various amounts to the other user account in a myriad of ways (e.g., in audio rooms, during a live stream, to a social media post (photo and/or video), and/or any other social media content). It is further envisioned that the funds accessed can be forms of digital currency (e.g., cryptocurrency).

In some examples, the first social media application may provide monetization statistics to the first user account. For example, the first social media application may track monetization (e.g., number of loves gained, number of subscribers, etc.) of particular content posted by the first user account over various periods (e.g., weekly, monthly, quarterly, yearly, time of the day, and/or day of the week) of time. Further, the first social media application may categorize, and track content—content specific for the account or content across a plurality of accounts—based on type, for example, tracking of live streams. The first social media application may use the monetization statistics to suggest to the first user account optimal times to post certain media.

Another example may include a method for facilitating subscription to a content creator account. The method may include receiving, by a first social media application, a user request from a first user account to subscribe to a content creator account. In some examples, purchasing a subscription may be necessary to access certain content, i.e., subscription based content, from the content creator account. The first social media application may store and update attributes of the first user account such as browsing preferences, social media activity, content subscriptions, and/or the like. Once the user request is transmitted by the first user account to the first social media application, the first social media application can update the first user account attributes such that the first social media application displays various content shared by the content creator account with the first user account. Further, the first social media application may provide notifications to the first user account when the content creator account shares content on the first social media application. In turn, the first social media application may notify the content creator account about the first user account subscription.

According to another example, a non-fungible token (NFT) generation system is disclosed. The system may include a first social media application, and a cryptocurrency application that includes a crypto wallet. A user of the first social media application can upload content to her social media account and select an option to create an NFT. Then, the first social media application can verify that the content is original by scouring the first social media application, the Internet, and/or other social media applications. Next, the first social media application can transmit the content to the cryptocurrency application, that associates the content with the crypto wallet and adds the content to the blockchain as an NFT. Once the NFT is created, the cryptocurrency application can send a confirmation to the first social media application. After receipt of confirmation, the first social media application can sell the content as an NFT to users of the first social media application. The first social media application can also track sales to ensure that the content creator and each user responsible for buying and selling the content receives a portion of each sale. Thus, the content creator would receive, to her social media account, a percentage of each sale of her content. Similarly, each buyer would receive residuals to her social media account.

In another example, a method for social media profile migration is disclosed. The method may include receiving, by a first social media application, user credentials (e.g., username and/or password) for a second social media application, from a first user account of the first social media application. Then, in some examples, the first social media application may log into a second user account of the second social media application using the user credentials.

In other examples, social media profile migration may be performed without user credentials. In these examples, the first user account can provide the first social media application with either a second social media application user account name (second user account name) and/or a universal resource locator (URL) associated with the second user account.

Next, the first social media application may scrape, i.e., download all content (e.g., media, data, profile content, and/or the like) associated with the second user account. The first social media application may then verify that the content meets the first social media standards (e.g., the content is not lewd or, in some cases, the content is original) and that the content can be shared (e.g., the content type matches the content type displayed on the first social media application) by the first social media application. After verification, the first social media application may update the first user account to include the content scraped from the second user account.

In some examples, the first user account can request that certain media from the second social media application, rather than the entire profile, be shared on the first user account. This may apply to previous media on the second social media application as well as future media posted on the second social media application. Even further, the user can specify which type of content (e.g., reels that are thirty seconds or less) is automatically shared from the second social media application to the first social media application. Also, media from the first social media application can be shared in the same or similar manner with the second social media application.

Further features of the disclosed design, and the advantages offered thereby, are explained in greater detail hereinafter with reference to specific embodiments illustrated in the accompanying drawings, wherein like elements are indicated be like reference designators.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, serve to explain the principles of the disclosed technology. In the drawings:

FIG. 1 is a diagram of an example environment that may be used to implement one or more embodiments of the present disclosure;

FIG. 2 is an example flow chart for a method of establishing a monetized social media profile from the prospective of a user device;

FIG. 3 is another example flow chart for a method of establishing a social media profile from the prospective of a social media provider server;

FIG. 4 is an example flow chart for a method of enabling subscriptions to a social media profile from the prospective of a social media provider server;

FIGS. 5A-5E illustrate an audio soundbar in various implementations with a social media application, according to example embodiments;

FIGS. 6A-6C depict monetization in audio rooms of the social media application, according to example embodiments;

FIGS. 7A-7C show monetization in live streams of the social media application, according to example embodiments;

FIGS. 8A and 8B illustrate a big love feature of the social media application, according to example embodiments;

FIGS. 9A-9E depict a process for subscription to a content creator account, according to example embodiments;

FIGS. 10A-10F illustrate a method for accessing content through virtual currency, according to example embodiments;

FIGS. 11A-11C show a process for accessing an audio room in the social media application using virtual currency, according to example embodiments;

FIGS. 12A and 12B depict a process for migrating social media content from a first social media application to a second social media application, according to example embodiments;

FIG. 13 illustrates a display of monetization statistics on the social media application, according to example embodiments;

FIG. 14 is a component diagram of an example of a user device, in accordance with some examples of the present disclosure; and

FIG. 15 is a component diagram of an example of a server, in accordance with some examples of the present disclosure.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Reference will now be made in detail to example embodiments of the disclosed technology, examples of which are illustrated in the accompanying drawings and disclosed herein. Wherever convenient, the same references numbers will be used throughout the drawings to refer to the same or like parts.

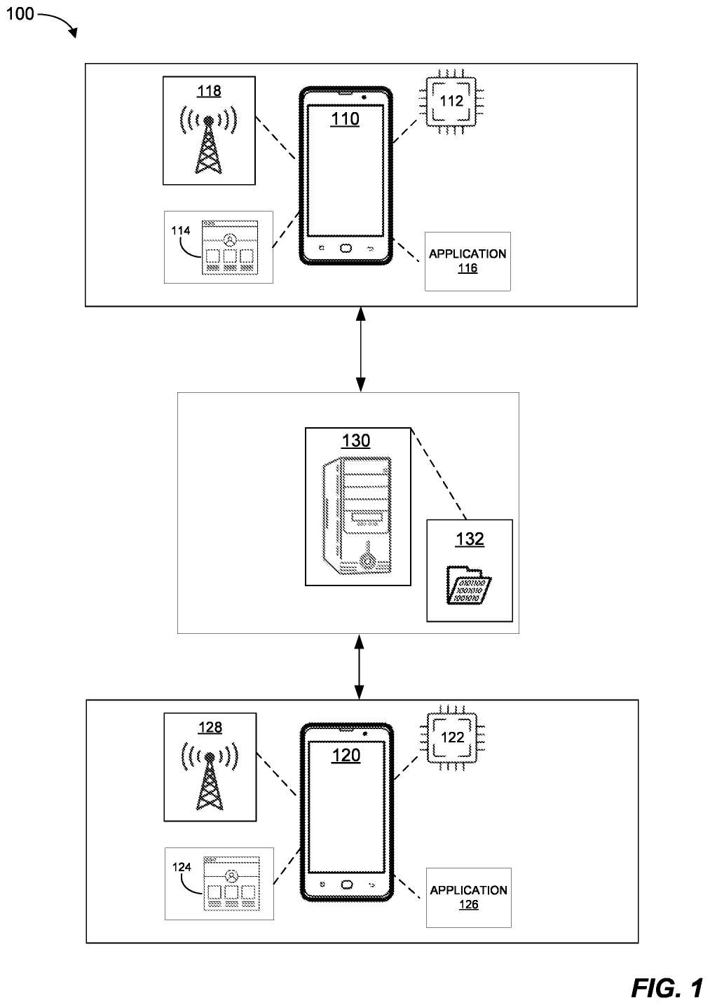

FIG. 1 shows an example system 100 that may implement certain methods for improved social media services as disclosed herein. As shown in FIG. 1, in some implementations the system 100 can include a first user device 110 (e.g., a smartphone), which may include a first processor 112, a first graphical user interface (first GUI) 114, a first social media application 116, and a first transceiver 118, a first social media provider server 130, which may include social media software 132, and a second user device 120 (e.g., a smartphone). Similar to the first user device 110, the second user device 120 may include a second processor 122, a second graphical user interface (second GUI) 124, a second social media application 126, and a second transceiver 128.

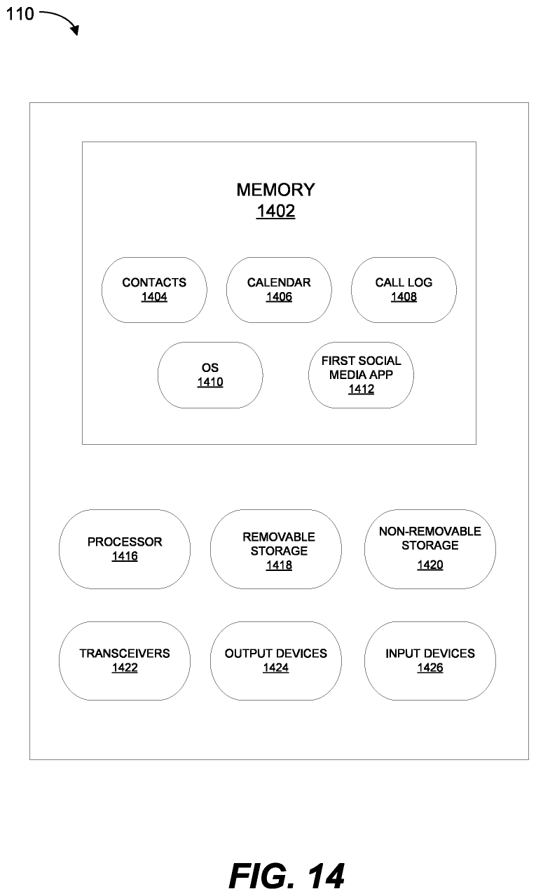

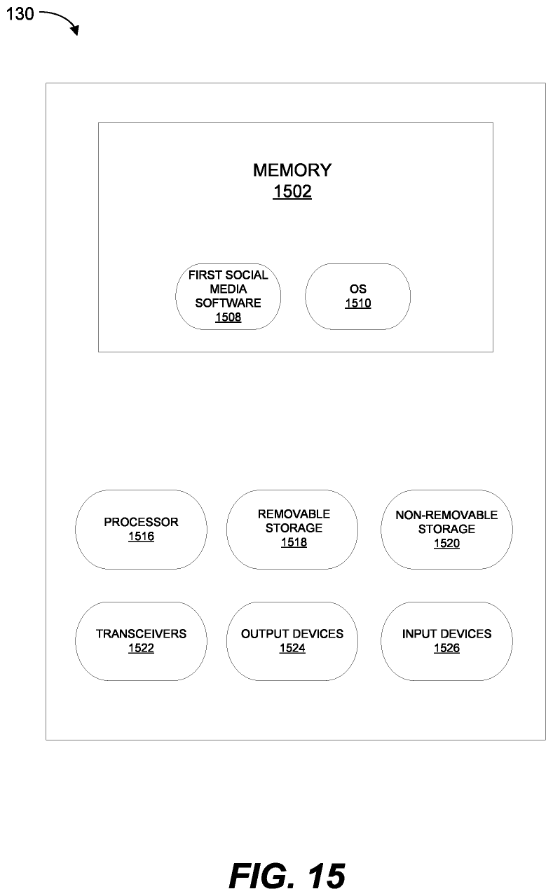

For purposes of this disclosure, the first user device 110 and the second user device 120 may perform the same or similar functions. The first user device 110 can be, for example, a personal computer, a smartphone, a smart television (TV), a laptop computer, a tablet, a wearable device (e.g., smart watch, smart jewelry, head-mounted displays, etc.), or other computing device. An example computer architecture that can be used to implement the first user device 110 is described below with reference to FIG. 14. The first social media provider server 130 can include one or more physical or logical devices (e.g., servers) or drives and may be implemented as a single server, a bank of servers (e.g., in a “cloud”), run on a local machine, or run on a remote server. An example computer architecture that can be used to implement the first social media provider server 130 is described below with reference to FIG. 15.

To receive social media services, a user of the first user device 110 (or the second user device 120) can download the first social media software 132 from the first social media provider server 130. After installation on the first user device 110, the first social media software 132 may appear as the first social media application 116. Next, a first social media profile can be established. To do so, the first social media provider server 130 may send a request for user data to the first user device 110 via the first social media application 116. Or, in some instances, the first social media software 132 may include instructions that cause the first social media application 116 to request user data from the user of the first user device 110 to establish the first social media profile. The user data can include demographics information (e.g., race, ethnicity, sex, gender, age, location, occupation, interests, etc.), financial information (e.g., routing number, account number, personal identification number, etc.), login credentials (e.g., username and/or password), biometric data, and/or a second social media profile (e.g., a TikTok® user profile).

The first social media provider server 130 can utilize the user data to generate a first social media profile, which may be viewable to other social media profiles hosted by the first social media provider server 130 and/or viewable through web browsers. In some instances, the first social media application 116 can utilize a second social media profile, hosted by a second social media provider server, to establish the first social media profile, for example, an Instagram® profile name may be provided to the first social media application 116, which then scrubs the available social media content (e.g., videos, profile data, photos, and/or the like) associated with the Instagram® profile, and then transmits at least some of the available social media content to the first social media provider server 130 to be associated with the first social media profile.

Alternately, the first social media provider server 130 may receive a named social media profile associated with a second social media provider server (not shown). Here, rather than receiving the social media content associated with the named social media profile from the first social media application 116, the first social media provider server 130 may communicate directly with the second social media provider server to obtain social media content associated with the named social media profile.

There are several other features that may be available to the first social media profile including subscribing to another social media profile, allowing other social media profiles to subscribe to the first social media profile, monetizing the first social media profile, and/or receiving multiple forms of social media content concurrently (e.g., a persistent audio bar playing music while photo content is displayed concurrently).

In substantially the same or similar manner as the first user device 110, the second user device 120 can perform social media services in tandem with the first social media provider server 130.

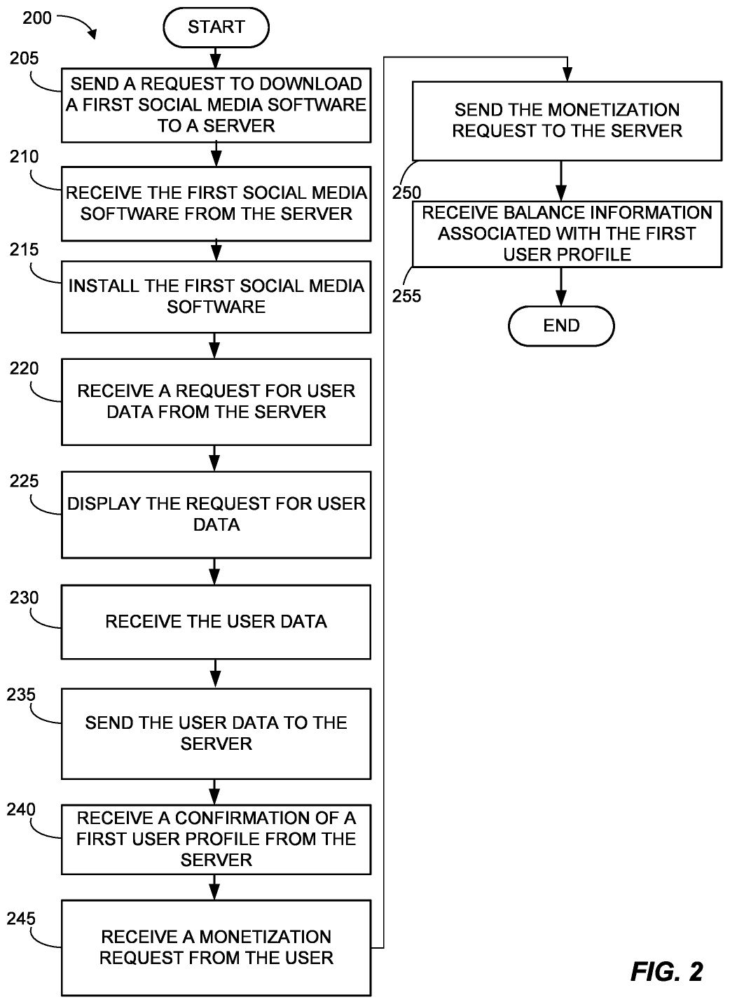

FIG. 2 depicts a method 200 of establishing a monetized social media profile from the prospective of a user device (e.g., first user device 110). At 205, the first user device 110 sends a request to the first social media provider server 130 to download first social media software 132. Next, at 210, the first user device 110 receives the first social media software 132, which may be installed, at 215, as the first social media application 116 on the first user device 110. Then, at 220, the first user device 110 receives a request for user data either locally from the first social media application 116 or from the first social media provider server 130.

At 225, the first user device 110 displays the request for user data on the first GUI 114. At 230, the first user device 110 receives the user data (e.g., demographics information). The user data may be manually entered by the user. Or, in some instances, step 225 may be bypassed, and instead, the first user device 110 may retrieve stored user data. Next, at 235, the first user device 110 sends the user data to the first social media provider server 130, which utilizes the user data to generate a first social media profile. After successful creation of the first social media profile, the first user device 110 receives confirmation, at 240.

Several features can be added to the first social media profile, for example, at 245, the user can initiate a monetization request with the first user device 110 (e.g., selecting a monetization option displayed on the first GUI 114). Next, at 250, the first user device 110 sends the monetization request to the first social media provider server 130. The monetization request can include various data including the user's financial information (e.g., financial institution name, routing number, account number, and/or the like). Once aspects of the first social media profile are properly monetized the first user device 110 can receive balance information, i.e., an amount of money accrued through monetization, at 255.

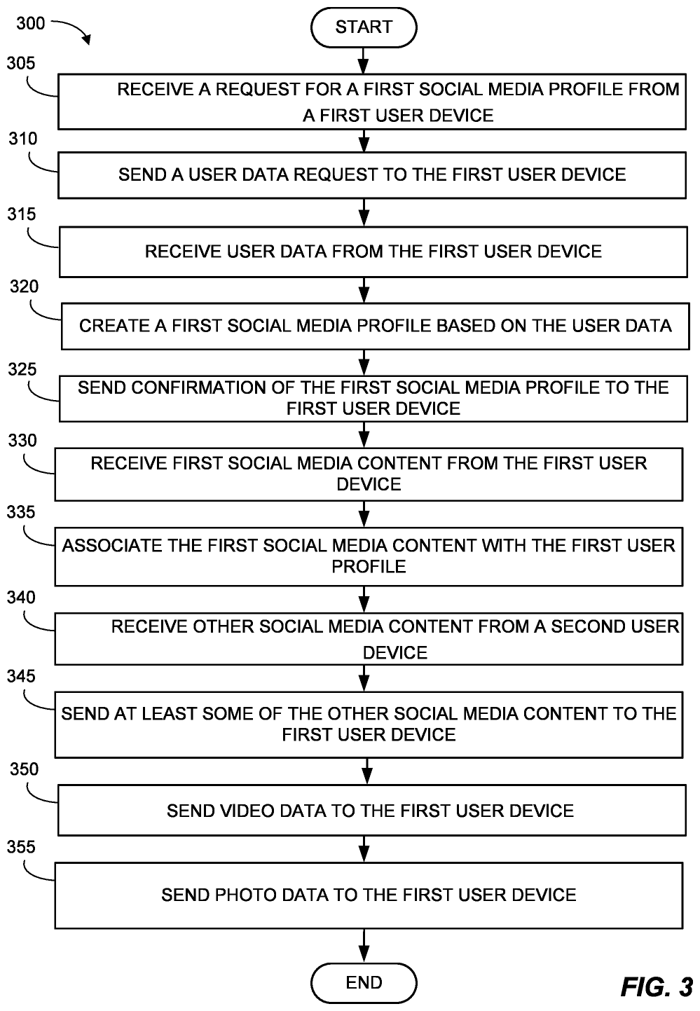

Turning to FIG. 3, which illustrates a method of establishing a social media profile from the prospective of a social media provider server (e.g., first social media provider server 130). At 305, the first social media provider server 130 receives a request to establish a first social media profile from the first user device 110. In some cases, this request may emanate from the first social media application 116, or, in other cases, this request may emanate as part of the user download of the first social media software 132. At 310, the first social media provider server 130 sends a request for user data (e.g., demographics information, financial information, a named social media profile) to the first user device 110. After receiving user data at 315, the first social media provider server 130 creates a first social media profile, at 320, utilizing at least in part the user data. Then, at 325, the first social media provider server 130 sends a confirmation of the first social media profile to the first user device 110. Next, at 330, the first social media provider server 130 receives first social media content (e.g., video(s), photo(s), audio, etc.) from the first user device 110. At 335, the first social media provider server 130 associates the first social media content with the first social media profile.

At 340, the first social media provider server 130 receives other social media content from the second user device 120. Then, at 345, the first social media provider server 130 sends at least some of the other social media content to the first user device 110, i.e., the user associated with the first social media profile can view at least some of the social media content posted by the user associated with the second social media profile, i.e., ssubscription-basedcontent. At 350, the first social media provider server 130 sends video data (e.g., social media content associated with a third social media profile) to the first user device, and, at 355, the first social media provider server 130 sends photo data (e.g., social media content associated with a fourth social media profile) to the first user device 110. Thus, the user associated with the first social media profile can view various forms of social media content from a plurality of social media profiles.

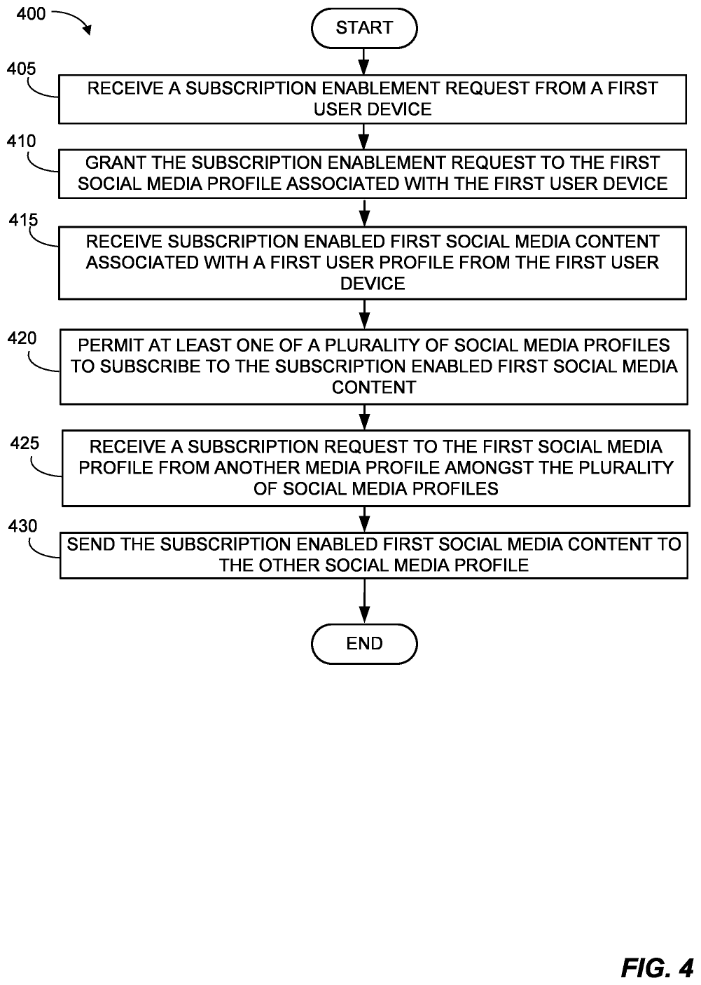

FIG. 4 depicts a method of enabling subscriptions to a social media profile from the prospective of a social media provider server (e.g., the first social media provider server 130). At 405, the first social media provider server 130 receives a subscription enablement request from the first user device 110. Next, the first social media provider server 130 processes the request, and, at 410, grants the subscription enablement request from the first user device 110. Then, at 415, the first social media provider server 130 receives subscription enabled first social media content associated with a first user profile from the first user device 110. Now that the first social media profile is enabled to receive subscribers, at 420, the first social media provider server 130 permits at least one of a plurality of social media profiles to subscribe to the subscription enabled first social media content.

In some instances, the first social media provider server 130 may add a feature to the first social media profile that notifies other social media profiles that they can subscribe to the first social media profile. At 425, the first social media provider server 130 receives a subscription request to the first social media profile from another social media profile amongst the plurality of social media profiles. Finally, at 430, the first social media provider server 130 sends the subscription enabled first social media content to the other social media profile.

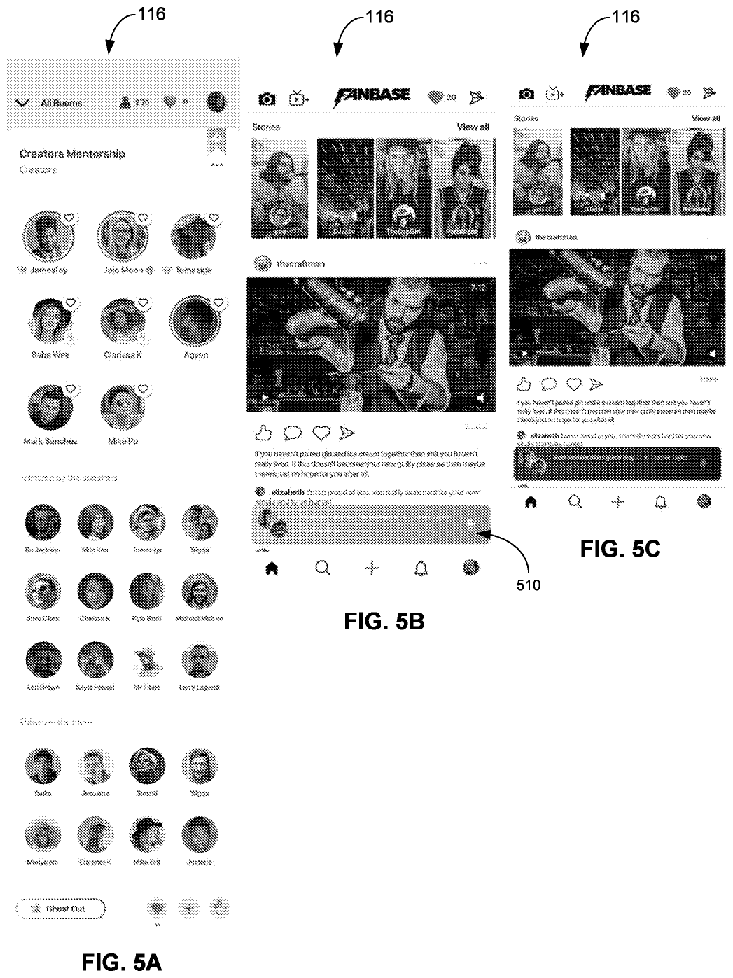

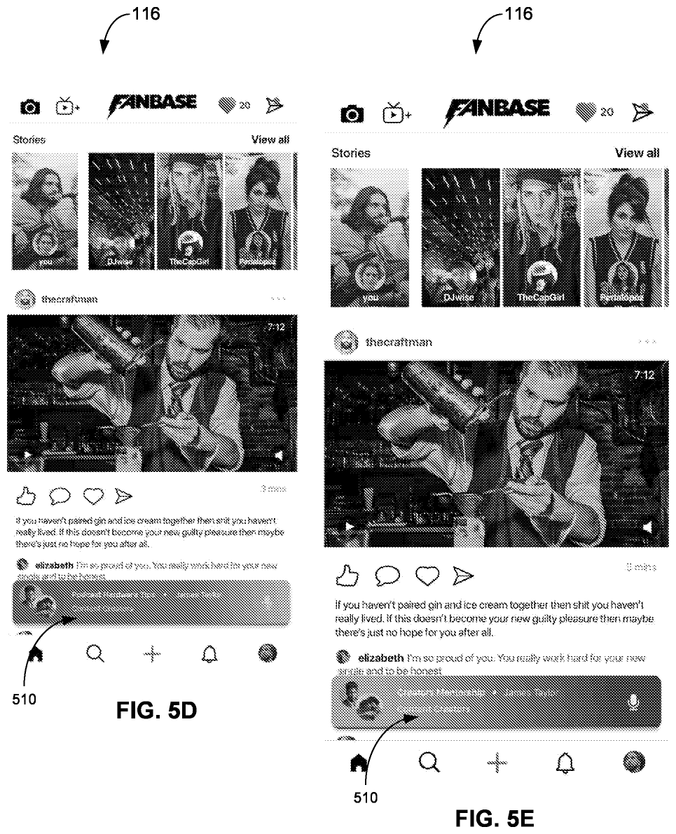

FIGS. 5A-5E illustrate an audio soundbar 510 that can be used as part of a social media application (e.g., the first social media application 116). As would be understood by one skilled in the art, the first social media application 116 and the audio soundbar 510 may be used with a smartphone, laptop, iPad, and/or any other computing device (e.g., the first computing device 110). The audio soundbar 510 allows users of the first social media application 116 to continuously listen to various sound (e.g., music, conversations in an audio room, a podcast, and/or radio), which may or may not be outputted by the social media application, while navigating the social media application. As shown in FIGS. 5B-5E, the audio soundbar 510 may appear as a graphic user interface (GUI) (e.g., first GUI 114) that can be positioned toward the bottom of the screen. Although this position is shown for the audio soundbar 510, the audio soundbar 510 can appear in various positions on the screen, and the audio soundbar 510 can be selected by the user and moved around the screen.

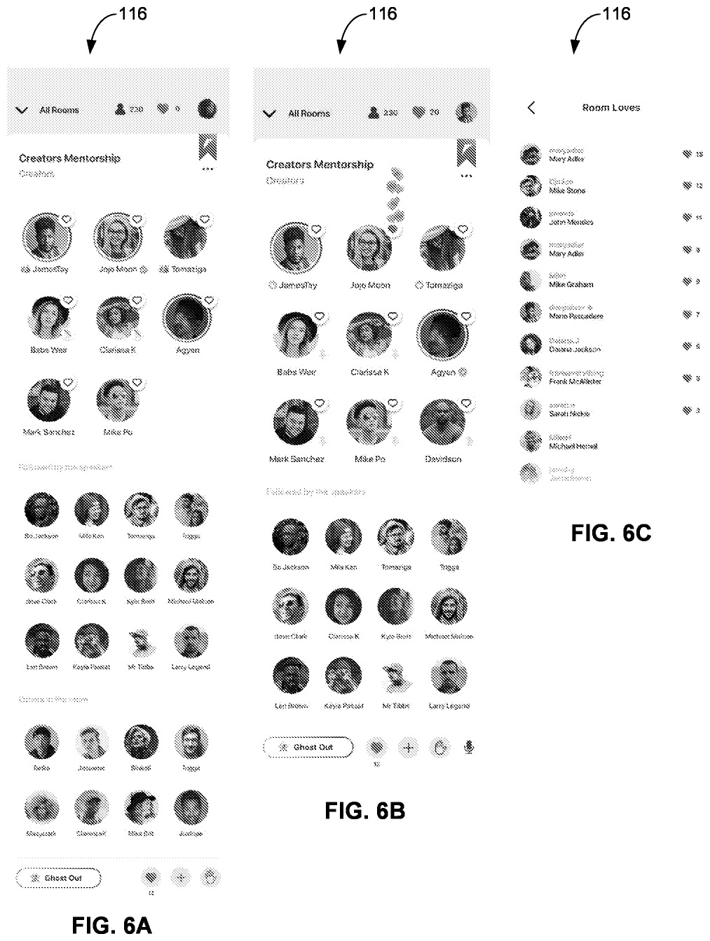

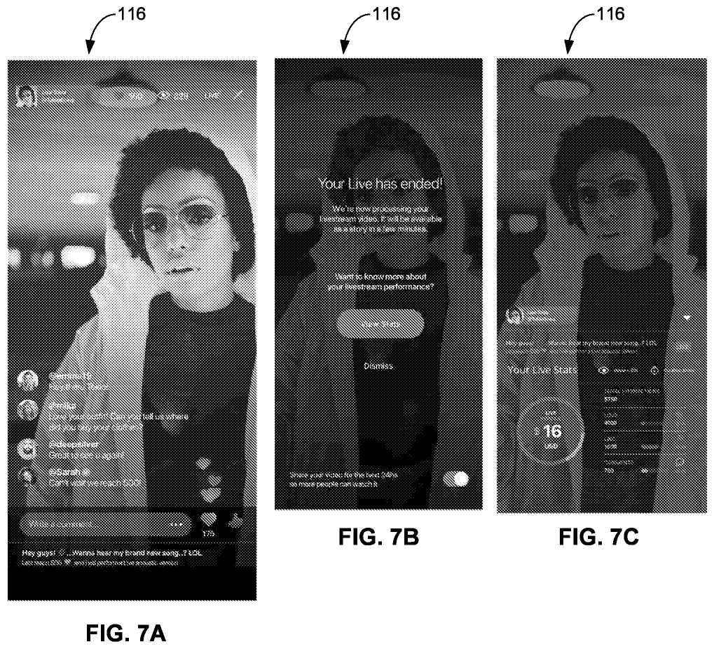

FIGS. 6A-6C depict monetization in audio rooms of the first social media application 116. Here, users of the first social media application 116 are in an audio room. While in the audio room, users can give each other “love,” which can be exchanged for currency. “Love” can be given in various increments, including increments of one, five, ten, or more. FIGS. 7A-7C show monetization in a live stream of the first social media application 116. Similar to giving “love” in an audio room, “love” can also be given during a live stream to the user who created the live stream. Practically speaking, this allows content creators, such as deejays, to receive “love” as they play music during a live stream. At the conclusion of a live stream (shown in FIG. 7B), the social media application can display live stream stats (shown in FIG. 7C), which include, for example, total interactions, love, like, comments, viewers, duration of the live stream, and/or live revenue.

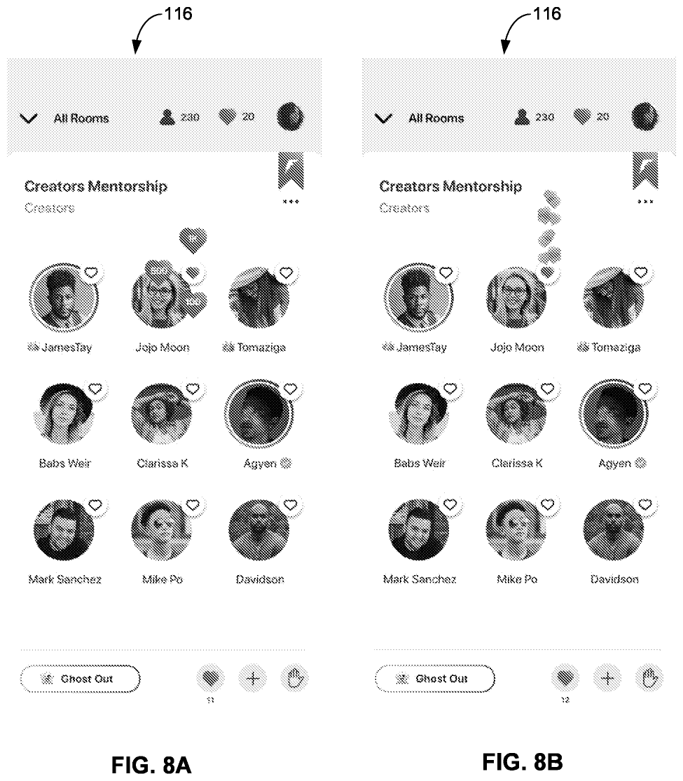

FIGS. 8A and 8B illustrate a big love feature of the first social media application 116. The big love can also be exchanged for currency on the first social media application 116. In the same or similar manner as the love feature, big love can be given during a live stream, in an audio chat room, in response to posted content, and/or long-form content. The big love feature includes increments of five hundred loves and one thousand loves, which can be modified increments of one by the user. Thus, a user of the social media application can give five hundred and five loves using the big love feature to, for example, a creator of a live stream.

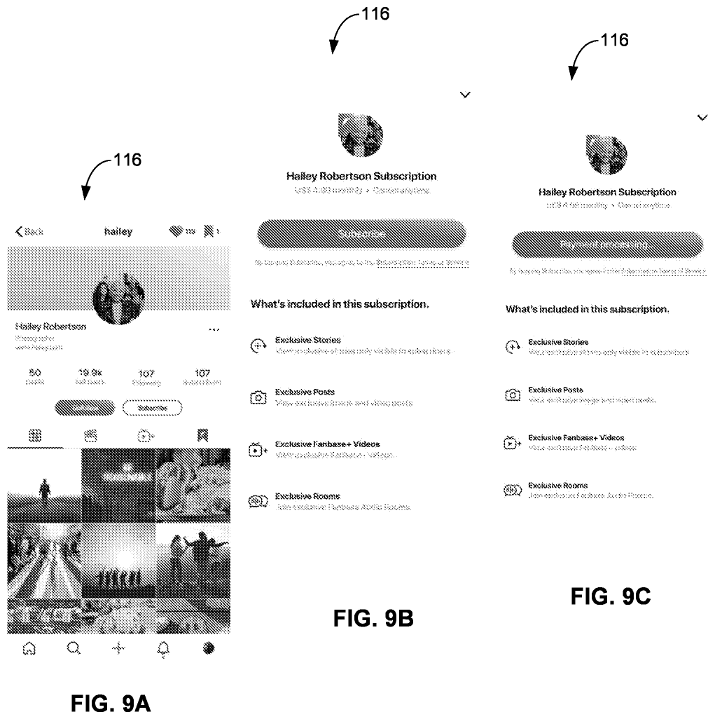

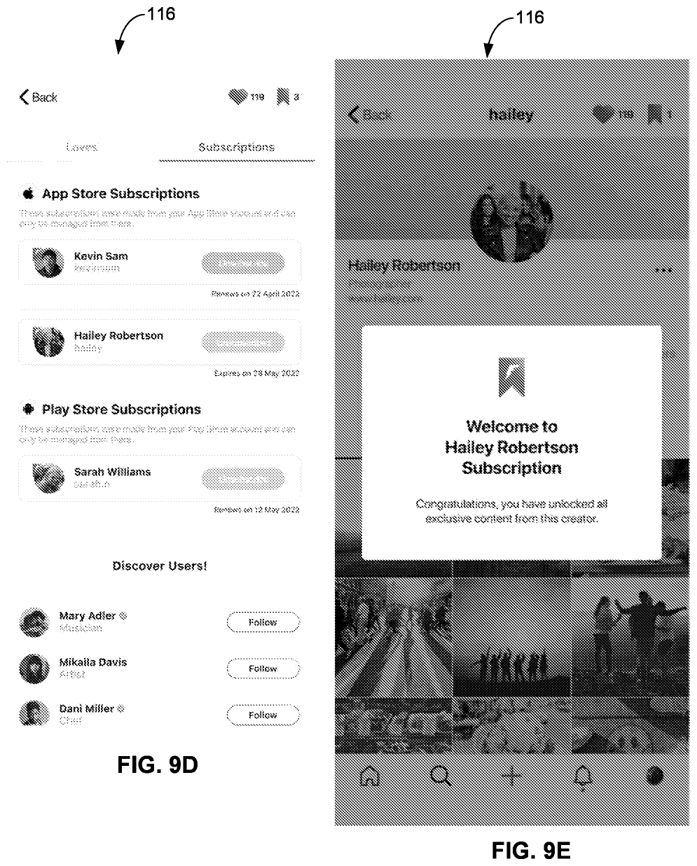

Users of the social media application can also subscribe to another user account (e.g., a content creator account). By subscribing, the user can access content shared by the content creator account. FIG. 9A shows a screen on the social media application where a first user account can subscribe to a content creator account. FIG. 9B shows the next step after selecting the “Subscribe” option from the content creator account. Next, FIG. 9C depicts payment processing required to subscribe to the content creator account. Turning to FIG. 9D, a confirmation screen after purchase of loves and/or a subscription is shown. Meanwhile, FIG. 9E shows a confirmation message after the first user account successfully subscribes to the content creator account.

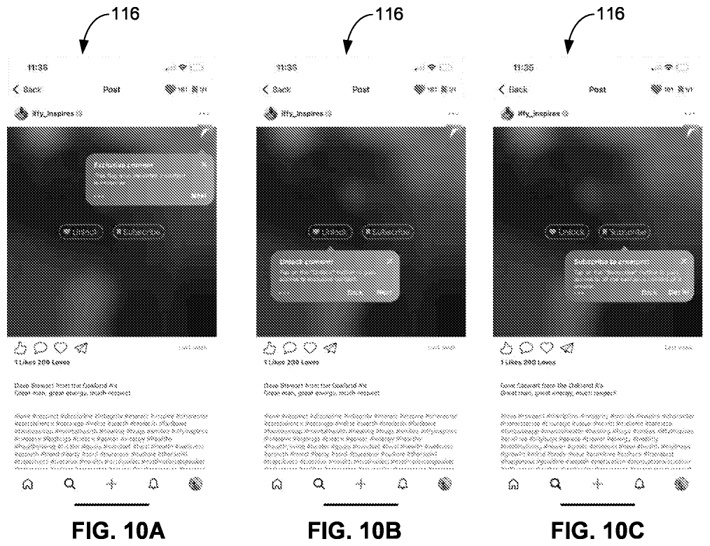

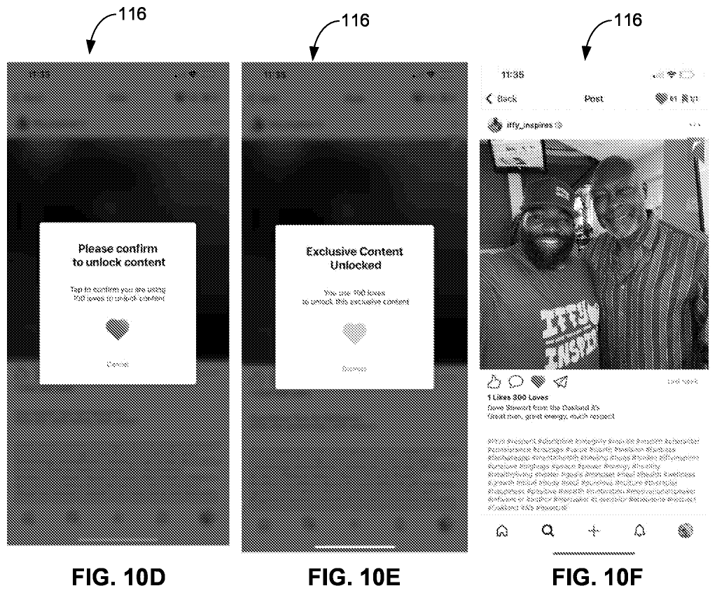

FIGS. 10A-10F illustrate a method for accessing content by exchanging virtual currency. As shown in FIG. 10A, a content creator can mark certain content as exclusive content, that can only be accessed by other users either paying for the exclusive content (shown in FIG. 10B) or by subscribing to the content creator (shown in FIG. 10C). As shown in FIGS. 10D and 10E, respectively, the social media application can seek confirmation of the purchase and send a notification upon successful purchase of the exclusive content. At FIG. 10F, the purchased exclusive content (a photo) is shown.

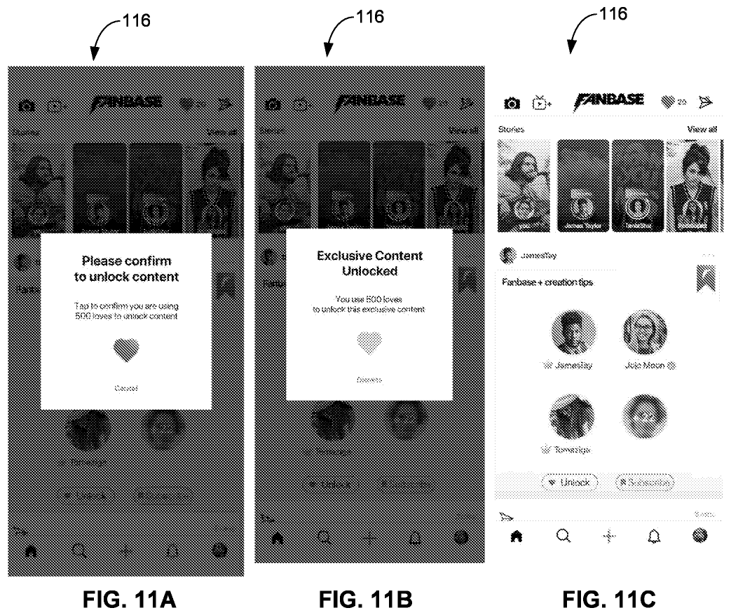

FIGS. 11A-11C show a process for accessing an audio room in the first social media application 116 using virtual currency (loves). Here, to access the exclusive content—the audio chat room, five hundred loves must be given to the creator of the audio room. FIG. 11A illustrates a confirmation screen seeking approval to spend five hundred loves to access, i.e., unlock, the audio chat room. FIG. 11B shows a confirmation message after successfully sharing the loves with the creator of the audio room, and FIG. 11C shows the audio room after it has been unlocked.

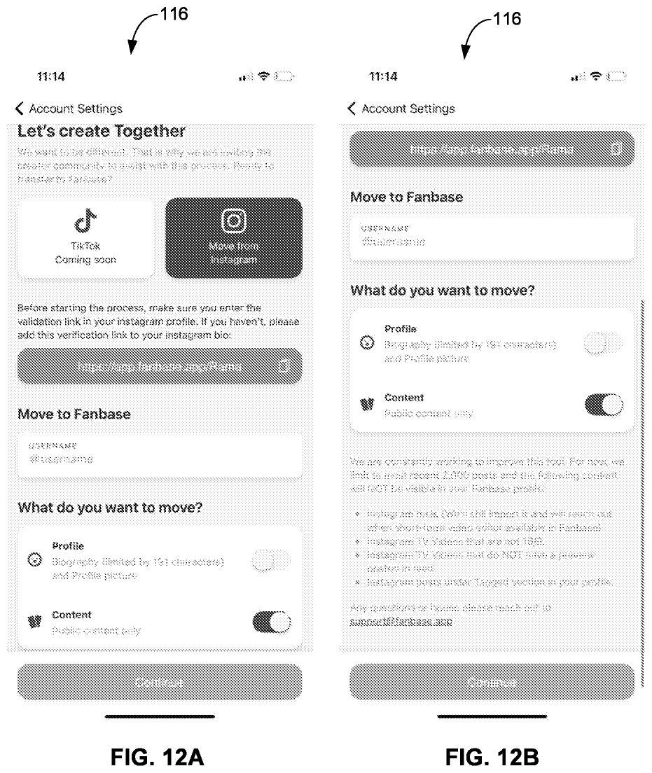

Turning to FIGS. 12A and 12B, a process of migrating content from a second social media platform to a first social media platform (e.g., first social media provider server 130) is shown. The migration process allows a user to transfer biography information and/or content (e.g., videos, photos) from the second social media application (e.g., Tik Tok®, Instagram®) to the first social media application 116. In addition, the first social media application 116 allows a new user to select a screen name for the first social media application.

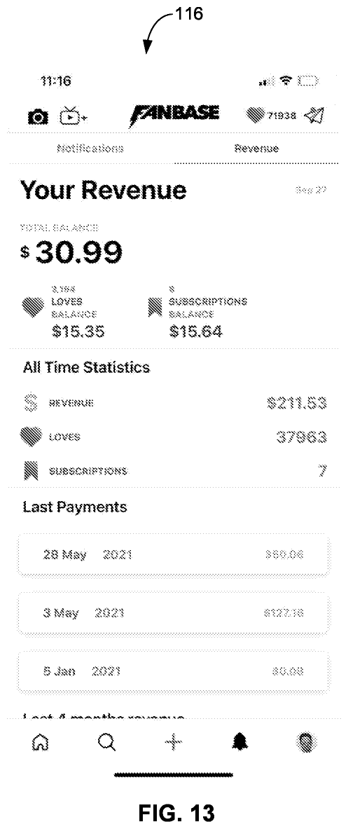

FIG. 13 illustrates a display of monetization statistics, for a particular user, on the first social media application 116. The first social media application 116 can display and track a user's current revenue (shown as total balance), loves, and subscriptions. Also, the first social media application 116 can track and display loves, revenue, and subscriptions acquired by the user throughout time. Furthermore, the first social media application 116 can be connected to a user wallet, bank card, or bank account, where the first social media application 116 can send payouts.

As shown in FIG. 14, some, or all, of the system 100 and methods 200, 300, and 400 can be performed by, and/or in conjunction with, the first user device 110 and/or the second user device 120. For brevity, only the first user device 110 shall be used to in the description of this figure. In some examples, the first user device 110 can comprise, for example, a cell phone, a smart phone, a smart television, a tablet computer, a laptop computer, a desktop computer, a sever, or other electronic device. One of skill in the art will recognize, however, that the system 100 and methods 200, 300, and 400 can also be used with a variety of other electronic devices, such as, for example, tablet computers, laptops, desktops, and other network (e.g., cellular or internet protocol (IP) network) connected devices from which a call may be placed, a text may be sent, and/or data may be received. These devices are referred to collectively herein as the first user device 110. The first user device 110 can comprise a number of components to execute the above-mentioned functions and apps. As discussed below, the first user device 110 comprise memory 1402 including many common features such as, for example, contacts 1404, a calendar 1406, a call log (or, call history) 1408, and OS 1410. In this case, the memory 1402 can also store a first social media app 1412.

The first user device 110 can also comprise one or more processors 1416. In some implementations, the processor(s) 1416 can be a central processing unit (CPU), a graphics processing unit (GPU), or both CPU and GPU, or any other sort of processing unit. The first user device 110 can also include one or more of removable storage 1418, non-removable storage 1420, one or more transceiver(s) 1422, output device(s) 1424, and input device(s) 1426.

In various implementations, the memory 1402 can be volatile (such as random-access memory (RAM)), non-volatile (such as read only memory (ROM), flash memory, etc.), or some combination of the two. The memory 1402 can include all, or part, of the functions 1404, 1406, 1408, 1412, and the OS 1410 for the first user device 110, among other things.

The memory 1402 can also comprise contacts 1404, which can include names, numbers, addresses, and other information about the user's business and personal acquaintances, among other things. In some examples, the memory 1402 may also include a calendar 1406, or other software, to enable the user to track appointments and calls, schedule meetings, and provide similar functions. In some examples, the memory 1402 can also comprise the call log 1408 of calls received, missed, and placed from the first user device 110. As usual, the call log 1408 can include timestamps for each call for use by the system 100. Of course, the memory 1402 can also include other software such as, for example, e-mail, text messaging, social media, and utilities (e.g., calculators, clocks, compasses, etc.).

The memory 1402 can also include the OS 1410. Of course, the OS 1410 varies depending on the manufacturer of the first user device 110 and currently comprises, for example, iOS 14.4.2 for Apple products and Pie for Android products. The OS 1410 contains the modules and software that supports a computer's basic functions, such as scheduling tasks, executing applications, and controlling peripherals.

As mentioned above, the first user device 110 can also include the first social media app 1412. The first social media app 1412 can perform some, or all, of the functions discussed above with respect to the methods 200, 300, and 400 for interactions occurring between the first user device 110, the first social media provider server 130, and the second user device 120. Thus, the first social media app 1412 can transmit user data to the first social media provider server 130. Additionally, the first social media app 1412 can receive first social media content from the user and transmit the user data to the first social media provider server 130. The first social media app 1412 also can receive, from the first social media provider server 130, social media content from various other social media profiles associated with the first social media application. Based on the user preferences and the location information, the first social media app 1412 can generate demographics information. Further, the first social media app 1412 can interact with the contacts 1404 to identify contacts who have profiles on the first social media application.

The first user device 110 can also include additional data storage devices (removable and/or non-removable) such as, for example, magnetic disks, optical disks, or tape. Such additional storage is illustrated in FIG. 14 by removable storage 1418 and non-removable storage 1420. The removable storage 1418 and non-removable storage 1420 can store some, or all, of the functions 1404, 1406, 1408, 1412, and the OS 1410.

Non-transitory computer-readable media may include volatile and nonvolatile, removable and non-removable tangible, physical media implemented in technology for storage of information, such as computer readable instructions, data structures, program modules, or other data. The memory 1402, removable storage 1418, and non-removable storage 1420 are all examples of non-transitory computer-readable media. Non-transitory computer-readable media include, but are not limited to, RAM, ROM, electronically erasable programmable ROM (EEPROM), flash memory or other memory technology, compact disc ROM (CD-ROM), digital versatile disks (DVD) or other optical storage, magnetic cassettes, magnetic tape, magnetic disk storage or other magnetic storage devices, or any other tangible, physical medium which can be used to store the desired information and which can be accessed by the first user device 110. Any such non-transitory computer-readable media may be part of the first user device 110 or may be a separate database, databank, remote server, or cloud-based server.

In some implementations, the transceiver(s) 1422 include any sort of transceivers known in the art. In some examples, the transceiver(s) 1422 can include wireless modem(s) to facilitate wireless connectivity with the other user devices, the Internet, and/or an intranet via a cellular connection.

In other examples, the transceiver(s) 1422 can include wired communication components, such as a wired modem or Ethernet port, for communicating with the other user devices or the provider's Internet-based network. In this case, the transceiver(s) 1422 can also enable the first user device 110 to communicate with the first social media provider server 130, as described herein.

In some implementations, the output device(s) 1424 include any sort of output devices known in the art, such as a display (e.g., a liquid crystal or thin-film transistor (TFT) display), a touchscreen display, speakers, a vibrating mechanism, or a tactile feedback mechanism. In some examples, the output device(s) 1424 can play various sounds based on, for example, whether the first user device 110 is connected to a network, the type of call being received (e.g., video calls vs. voice calls), the number of active calls, etc. In some examples, the output device(s) can play a sound when the first social media app 1412 is successfully downloaded, when the user enters user preferences, etc. Output device(s) 1424 can also include ports for one or more peripheral devices, such as headphones, peripheral speakers, or a peripheral display.

In various implementations, input device(s) 1426 can include any sort of input devices known in the art. The input device(s) 1426 can include, for example, a camera, a microphone, a keyboard/keypad, or a touch-sensitive display. A keyboard/keypad may be a standard push button alphanumeric, multi-key keyboard (such as a conventional QWERTY keyboard), virtual controls on a touchscreen, or one or more other types of keys or buttons, and may also include a joystick, wheel, and/or designated navigation buttons, or the like.

As shown in FIG. 15, the system 100 and methods 200, 300, and 400 can also be used in conjunction with the first social media provider server 130. The first social media provider server 130 can comprise, for example, a desktop or laptop computer, a server, bank of servers, or cloud-based server bank. Thus, while the first social media provider server 130 is depicted as single standalone servers, other configurations or existing components could be used.

In various implementations, the memory 1502 can be volatile (such as random-access memory (RAM)), non-volatile (such as read only memory (ROM), flash memory, etc.), or some combination of the two. The memory 1502 can include all, or part, of the functions of first social media software 1508, among other things. The memory 1502 may also include the OS 1510. Many servers, for example, run Linux or Windows Server. The OS 1510 contains the modules and software that supports a computer's basic functions, such as scheduling tasks, executing applications, and controlling peripherals.

The first social media provider server 130 can also comprise one or more processors 1516, which can include a central processing unit (CPU), a graphics processing unit (GPU), or both CPU and GPU, or any other sort of processing unit. The first social media software 1508 can provide the first social media provider server 130 communication with the second user device 120 and/or the first user device 110. Thus, the first social media software 1508 can receive demographics information, location information, user preferences, and other information from the second user device 120 and/or the first user device 110. Also, the first social media software 1508 can receive and distribute social media content from and to the second user device 120 and/or the first user device 110.

The first social media provider server 130 can also include additional data storage devices (removable and/or non-removable) such as, for example, magnetic disks, optical disks, or tape. Such additional storage is illustrated in FIG. 15 by removable storage 1518 and non-removable storage 1520. The removable storage 1518 and non-removable storage 1520 may store some, or all, of the OS 1510 and functions 1508.

Non-transitory computer-readable media may include volatile and nonvolatile, removable and non-removable tangible, physical media implemented in technology for storage of information, such as computer readable instructions, data structures, program modules, or other data. The memory 1502, removable storage 1518, and non-removable storage 1520 are all examples of non-transitory computer-readable media. Non-transitory computer-readable media include, but are not limited to, RAM, ROM, EEPROM, flash memory or other memory technology, CD-ROM, DVDs or other optical storage, magnetic cassettes, magnetic tape, magnetic disk storage or other magnetic storage devices, or any other tangible, physical medium which may be used to store the desired information, and which can be accessed by the first social media provider server 130. Any such non-transitory computer-readable media may be part of the first social media provider server 130 or can be a separate database, databank, remote server, or cloud-based server.

In some implementations, the transceiver(s) 1522 include any sort of transceivers known in the art. In some examples, the transceiver(s) 1522 may include wireless modem(s) to facilitate wireless connectivity with the first user device 110, the Internet, and/or an intranet via a cellular connection. Further, the transceiver(s) 1522 can include a radio transceiver that performs the function of transmitting and receiving radio frequency communications via an antenna (e.g., Wi-Fi or Bluetooth®). In other examples, the transceiver(s) 1522 can include wired communication components, such as a wired modem or Ethernet port, for communicating with the other user devices or the provider's Internet-based network. The transceiver(s) 1522 can retrieve user data (e.g., data associated with a user profile) from memory 1502.

In some implementations, the output device(s) 1524 include any sort of output devices known in the art, such as a display (e.g., a liquid crystal or thin-film transistor (TFT) display), a touchscreen display, speakers, a vibrating mechanism, or a tactile feedback mechanism. In some examples, the output devices may play various sounds based on, for example, whether the first social media provider server 130 is connected to a network, the type of data being received (e.g., user data vs. social media content), when the request is being transmitted, etc. Output device(s) 1524 also include ports for one or more peripheral devices, such as headphones, peripheral speakers, or a peripheral display.

In various implementations, input device(s) 1526 include any sort of input devices known in the art. For example, the input device(s) 1526 can include a camera, a microphone, a keyboard/keypad, or a touch-sensitive display. A keyboard/keypad may be a standard push button alphanumeric, multi-key keyboard (such as a conventional QWERTY keyboard), virtual controls on a touchscreen, or one or more other types of keys or buttons, and may also include a joystick, wheel, and/or designated navigation buttons, or the like.

The specific configurations, machines, and the size and shape of various elements can be varied according to particular design specifications or constraints requiring the first user device 110, the first social media provider server 130, the second user device 120, system 100, or method 200, 300, 400 constructed according to the principles of this disclosure. Such changes are intended to be embraced within the scope of this disclosure. The presently disclosed examples, therefore, are considered in all respects to be illustrative and not restrictive. The scope of the disclosure is indicated by the appended claims, rather than the foregoing description, and all changes that come within the meaning and range of equivalents thereof are intended to be embraced therein.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain examples and implementations of the disclosed technology are described above with reference to block and flow diagrams of systems and methods and/or computer program products according to example examples or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some examples or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, examples or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some examples,” “example embodiment,” “various examples,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising,” “containing,” or “including” it is meant that at least the named element, or method step is present in article or method, but does not exclude the presence of other elements or method steps, even if the other such elements or method steps have the same function as what is named.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain examples of this disclosure have been described in connection with what is presently considered to be the most practical and various examples, it is to be understood that this disclosure is not to be limited to the disclosed examples, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain examples of the technology and also to enable any person skilled in the art to practice certain examples of this technology, including making and using any apparatuses or systems and performing any incorporated methods. The patentable scope of certain examples of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for improved social media comprising:
sending, by a transceiver of a user device, a request to download a first social media application software to a server;
receiving, by the transceiver, the first social media application software from the server;
installing, by a processor of the user device, the first social media application software as a first social media application onto the user device;
receiving, by the transceiver, a request for user data from the server;
displaying, by the processor on a screen of the user device, the request for user data;
receiving, by the processor, the user data;
sending, by the first social media application via the transceiver, the user data to the server;
receiving, by the transceiver, a confirmation of a first user profile from the server;
receiving, by the first social media application, a monetization request; and
sending, by the transceiver, the monetization request to the server.

2. The method of claim 1, further comprising:
displaying, by the processor on the screen of the user device, a plurality of audio data;
receiving, by the processor via a first graphical user interface (first GUI) of the user device, a user selection from the plurality of audio data;
sending, by the transceiver, the user selection to the server;
receiving, by the transceiver, audio content representative of the user selection from the server; and
outputting, by a speaker of the user device, the audio content.

3. The method of claim 2, further comprising:
receiving, by the transceiver, at least one of video content and photo content from the server; and
outputting at least one of video content and photo content simultaneously with the audio content.

4. The method of claim 1, wherein the user data includes at least one of: login credentials of the first social media application, biometric data, a second social media profile associated with a second social media application, demographics information, and financial institution information.

5. The method of claim 1, further comprising:
receiving, by the transceiver, balance information associated with the first user profile.

6. The method of claim 6, wherein the balance information is based on social engagement from at least one other user profile.

7. The method of claim 1, further comprising:
receiving, by the first social media application, a subscription request to a content creator profile;
sending, by the transceiver, the subscription request to the server;
sending, by the transceiver, payment information to the server; and
receiving, by the transceiver, a status of the subscription request from the server.

8. A method for improved social media comprising:
receiving, by a server, a request for a first user profile from a first user device;
sending, by the server, a user data request to the first user device;
receiving, by the server, user data from the first user device;
creating, by the server, a first user profile based at least in part on the user data;
sending, by the server, confirmation of the first user profile to the first user device;
receiving, by the server, first social media content from the first user device;
associating, by the server, the first social media content with the first user profile;
receiving, by the server, a subscription enablement request from the first user device; and
permitting, by the server, at least one of a plurality of user profiles to subscribe to at least a portion of the first social media content.

9. The method of claim 8, further comprising:
receiving, by the server, other social media content from at least one of the plurality of user profiles; and
sending, by the server, at least some of the other social media content to the first user device.

10. The method of claim 9, wherein:
the first social media content comprises at least one of audio content, video content, and photo content; and
the other social media content comprises at least one of audio content, video content, and photo content.

11. The method of claim 10, further comprising:
sending, by the server, audio content simultaneously with at least one of the video content and the photo content to the first user device.

12. The method of claim 8, further comprising:
receiving, by the server, a monetization request from the first user device;
calculating, by the server, balance information based on social engagement of the plurality of user profiles with the first social media content, wherein the social engagement includes at least one of profile visits, unique profile visits, views, likes, and comments; and
associating, by the server, the balance information with the first user profile.

13. The method of claim 12, further comprising:
generating, by the server, a monetization suggestion for the first user profile based on the social engagement, wherein the monetization suggestion includes at least one of optimal posting times, optimal posting content, and optimal target audience; and
sending, by the server, the monetization suggestion the first user device associated with the first user profile.

14. The method of claim 8, further comprising:
receiving, by the server, a subscription request to the first user profile from a second user profile amongst the plurality of user profiles; and
sending, by the server, the at least a portion of the first social media content to the second user profile.

15. The method of claim 14, wherein the subscription request comprises sending payment to a payment account of the first user profile from a payment account of the second user profile.

16. A system for improved social media comprising:
one or more processors; and
memory, in communication with the one or more processors, storing instructions that, when executed, cause the one or more processors to:
receive a request for a first user profile from a first user device;
send a user data request to the first user device;
receive user data from the first user device;
create a first user profile based at least in part on the user data;
send confirmation of the first user profile to the first user device;
receive first social media content from the first user device;
associate the first social media content with the first user profile;
receive a subscription enablement request from the first user device;
permit at least one of a plurality of user devices to subscribe to at least a portion of the first social media content;
receive a monetization request from the first user device; and
permit monetization by the first user profile.

17. The system of claim 16, wherein the one or more processor is further configured to:
determine social engagement by the plurality of user devices with the first user profile; and
calculate balance information for the first user profile based on the social engagement.

18. The system of claim 17, wherein determining social engagement is based on at least one of profile visits, unique profile visits, views, likes, and comments.

19. The system of claim 16, wherein the one or more processors is further configured to:
receive a subscription request to the first user profile from a second user profile amongst the plurality of user devices; and
send the at least a portion of the first social media content to the second user profile.

20. The system of claim 19, wherein the one or more processors is further configured to:
send, to the first user device, audio content simultaneously with the first social media content, wherein the first social media content includes at least one of video content and photo content.
